(19) United States
(12) Patent Application Publication
(10) Pub. No.: US 2012/0151027 A1
(43) Pub. Date: Jun. 14, 2012

(54) POLICY DRIVEN DYNAMIC COMPOSITION OF SERVICE DATAFLOWS

(75) Inventors: Timothy W. BANKS, Winchester (GB); Paolo Dettori, Hartsdale, NY (US); Julio Nogima, Tarrytown, NY (US); Robert W. Phippen, Romsey (GB); Frank A. Schaffa, Hartsdale, NY (US)

(73) Assignee: International Business Machines Corporation, Armonk, NY (US)

(21) Appl. No.: 12/967,553

(22) Filed: Dec. 14, 2010

(51) Int. Cl. G06F 15/173

(52) U.S. Cl. 709/223

(57) ABSTRACT

An information processing system receives a request from a client. A first set of dataflows that enforces at least one set of policies is retrieved in response to receiving the request. Each dataflow in the first set of dataflows is a software component that processes a set of messages sent from the client to a service. A dataflow execution plan is generated that include the first set of dataflows. At least one dataflow in the first set of dataflows is determined to be associated with a dataflow policy. At least a second set of dataflows associated with the dataflow policy is retrieved in response to the determining. At the at least second set of dataflows is inserted into the dataflow execution plan preceding the at least one dataflow.

### BACKGROUND

The present invention generally relates to service dataflows, and more particularly relates to the composition of service dataflows.

A dataflow is a software component which processes messages sent from a client to a service such as a web service. Current approaches for dataflow composition generally require a situational approach where specific dataflows have to be manually constructed and statically composed before runtime for specific policies requirements. These conventional approaches are unable to overcome the increasingly complex challenges for consuming these services because they are limited in scope and functionality. For example, in some conventional systems a programmer is required to create specialized dataflows based on particular policies before runtime. Other systems require manual work and intervention.

### BRIEF SUMMARY

In one embodiment, a method is disclosed. The method comprises receiving a request from a client. A first set of dataflows associated with the at least one service is retrieved. A dataflow processes messages sent from the client to a service. A dataflow execution plan comprising the first set of dataflows is generated. At least one dataflow in the set of dataflows is determined to be associated with a service policy. A second set of dataflows associated with the service policy is retrieved in response to the determination. The second set of dataflows is inserted into the dataflow execution plan preceding the at least one dataflow.

In another embodiment, a system is disclosed. The system comprises a data composition manager. The data composition manager is configured for receiving a request from a client. A first set of dataflows that enforce at least one set of policies is retrieved in response to receiving the request. Each dataflow in the first set of dataflows is a software component that processes a set of messages sent from the client to a service. A dataflow execution plan is generated that comprises the first set of dataflows. At least one dataflow in the first set of dataflows is determined to be associated with a dataflow policy. At least a second set of dataflows associated with the dataflow policy is retrieved in response to the determination. At the at least second set of dataflows is inserted into the dataflow execution plan preceding the at least one dataflow.

In yet another embodiment, a computer program product is disclosed. The computer program product comprises computer readable storage medium having computer readable program code embodied therewith. The computer readable program code comprising computer readable program code configured to receive a request from a client. A first set of dataflows that enforce at least one set of policies is retrieved in response to receiving the request. Each dataflow in the first set of dataflows is a software component that processes a set of messages sent from the client to a service. A dataflow execution plan is generated that comprises the first set of dataflows. At least one dataflow in the first set of dataflows is determined to be associated with a dataflow policy. At least a second set of dataflows associated with the dataflow policy is retrieved in response to the determination. At the at least second set of dataflows is inserted into the dataflow execution plan preceding the at least one dataflow.

In a further embodiment, a method is disclosed. The method comprises retrieving a dataflow execution plan comprising a set of dataflows. One of an endpoint of the dataflow execution plan and a dataflow in the dataflow execution plan is selected. An incoming message type required by the endpoint or dataflow that has been selected is determined. An output message type provided by one of a dataflow and service request in the dataflow execution plan immediately preceding the endpoint or dataflow that has been selected is determined. The incoming message type that has been determined and the output message type that has been determined are compared. A determination is made, based on the comparison, that the incoming message type and the output message type fail to match. A transformation dataflow is inserted into the dataflow execution plan immediately preceding the endpoint or the dataflow that has been selected. The transformation dataflow automatically transforms an output message of at least one of the dataflow and service request to the incoming message type required by the endpoint or dataflow that has been selected.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention;

FIG. 2 is a block diagram illustrating a detailed view of a dataflow composition manager according to one embodiment of the present invention;

FIG. 3 is a graph illustrating various dataflow classifications according to one embodiment of the present invention;

FIGS. 4-6 illustrate one example of performing dependency resolution for dataflows according to one embodiment of the present invention;

FIGS. 7-11 illustrate another example of performing dependency resolution for dataflows according to one embodiment of the present invention;

FIG. 12 is a graph illustrating dataflow dependencies for the example given in FIGS. 7-11 according to one embodiment of the present invention;

FIG. 13 illustrates one example of parameter propagation according to one embodiment of the present invention;

FIGS. 14-16 illustrate one example of performing automatic transformations of messages within an execution plan according to one embodiment of the present invention;

FIGS. 17-18 are operational flow diagrams illustrating one example of performing policy driven dynamic composition of data flows according to one embodiment of the present invention;

FIG. 19 is an operational flow diagram illustrating one example of a process for resolving dependencies in a dataflow execution plan according to one embodiment of the present invention;

FIG. 20 is an operational diagram illustrating one example of a process for performing automatic transformations of messages within an execution plan according to one embodiment of the present invention; and

FIG. 21 is a block diagram illustrating a detailed view of an information processing system according to one embodiment of the present invention.

### DETAILED DESCRIPTION

Operating Environment

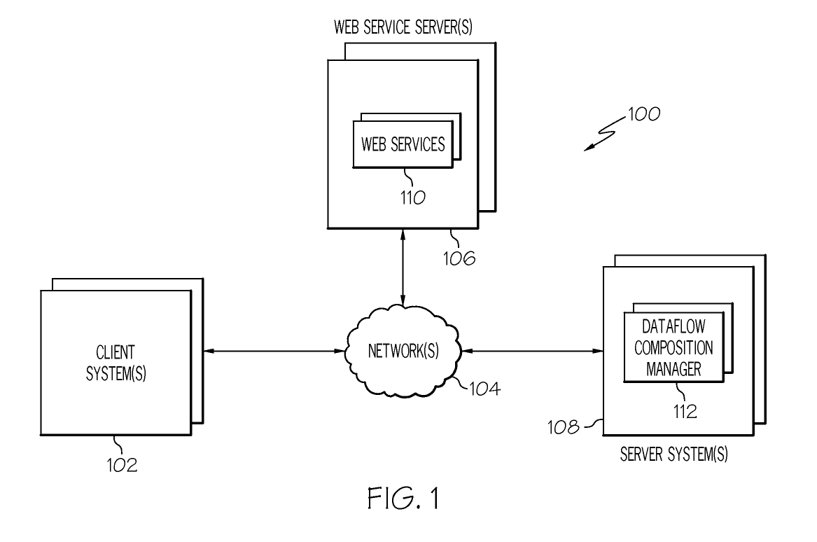

FIG. 1 shows one example of an operating environment 100 applicable to various embodiments of the present invention. The operating environment 100, in one embodiment, comprises one or more client systems 102 communicatively coupled to one or more networks 104. The client system(s) 102, in one embodiment, is a personal computer, a notebook computer, a workstation, a PDA, a cellular phone capable of browsing the Internet, and/or the like. The network(s) 104, according to one embodiment, comprises a LAN, WAN, World Wide Web, wireless network, or the like.

FIG. 1 also shows a plurality of server systems 106, 108 communicatively coupled to the network(s) 104 as well. In one embodiment, one or more of the server systems 106, comprise a set of services 110 that can be requested and utilized by the client system 102. One or more other server systems 108 comprise a dataflow composition manager 112 for dynamically and automatically (i.e., without user intervention) composing service dataflows based on policies. For example, the dataflow composition manager 112 dynamically and automatically determines a set of dataflows to compose based on declared policies and dependencies and also computes a composition plan that satisfies all of the policy constraints. In other words, the dataflow composition manager 112, based on a set of policies that are specified for a service, dynamically plans a set of reusable generic dataflows that are sequenced and invoked to satisfy the specified policies. The dataflow composition manager 112 is discussed in greater detail below. It should be noted that the one or more of the services 110 and at least a portion of the dataflow composition manager 112 can reside on the same system.

A dataflow, in one embodiment, is a software component that process messages sent from a client to a service. Dataflows can be used for functions such as data transformation, logging, and routing. A dataflow typically operates within a runtime environment such as, but not limited to, an Enterprise Service Bus (ESB), which is a software architecture that allows for the performance of complex tasks by a distributed set of middleware services, each service performing a particular component function.

In one embodiment, a service 110 associated with a dataflow is a web service. A web service is a software system which supports automatic interaction with a client over a network. A web service provides a machine-readable interface that describes how the service can be invoked. The policies associated with the dataflows, in this embodiment, are web service policies. A web service policy is a specification that describes the capabilities and constraints for a web service and the policy requirements for a web service client. For example, policies can be used to specify Quality of Service requirements for a client or security requirements for a service. Other policies may include logging, authentication, load balance, fail-over, access control and privacy. A policy has a scope, which determines where and when it applies, and has typically two concepts: the policy assertion, which describes the capabilities or requirements of the policy element it attaches to, and the policy subject, which is the element in the specified domain where the policy attaches to. A more detailed discussion on the definitions of Policy Subject, Policy Enforcement Point and Policy Decision Point can be found in the “Network Working Group Request for Comments: 3198 Category: Informational”, which is hereby incorporated by reference in its entirety.

Dataflow Composition Manager

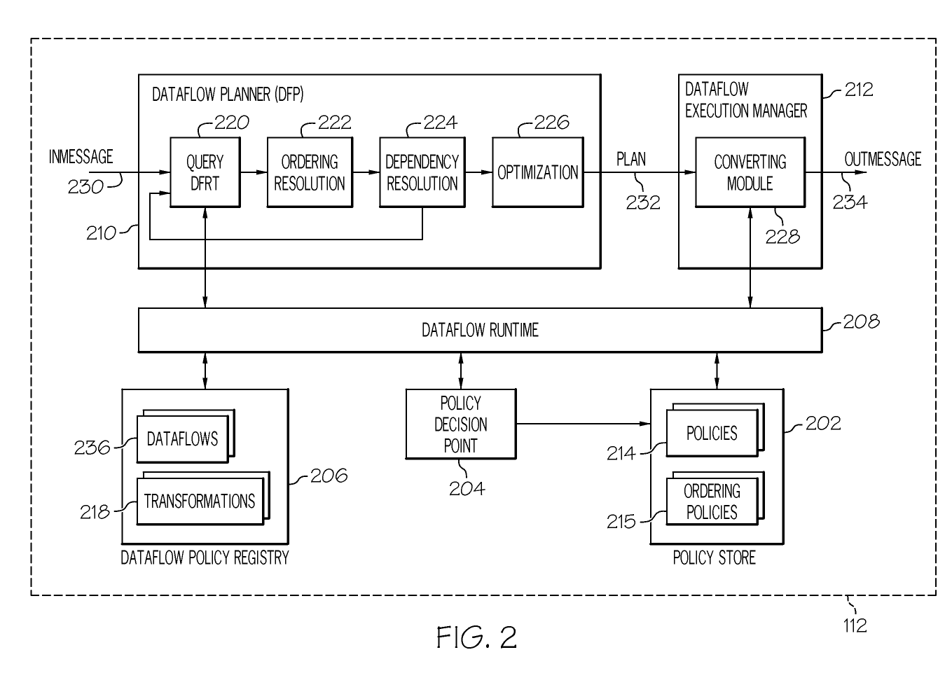

FIG. 2 shows a more detailed view of the dataflow composition manager 112. In particular, FIG. 2 shows a policy store 202, a policy decision point 204, and a dataflow/policy registry (DFPR) 206 communicatively coupled to a dataflow runtime (DFRT) 208. The DFPR 206 is communicatively coupled (through the DFRT 208) to a dataflow planner 210 and a dataflow execution manager 212, which is also communicatively coupled to the dataflow planner 210. The policy store 202 stores policies 214 and ordering policies 215. Each policy 214 comprises a set of assertions and the subjects to which they attach. In this context, a subject can be either an endpoint or a dataflow. The policy decision point 204, in one embodiment, interacts with the policy store 202 to determine the assertions that apply to a particular subject. For example, if a client 102 is invoking a given service the policy decision point 204 determines if a given policy in the policy store 202 applies to the given service endpoint. Ordering policies 215 are discussed in greater detail below.

The DFPR 206 comprises a dataflow definition 236 (dataflow) for each policy domain supported by the DFRT 208 that enforces that policy domain. The DFPR 206 also comprises a transformation 218 for each of the policy domains that specifies how to map from an assertion in that domain to a parameterization of the dataflow. The DFPR 206 identifies the dataflow required for satisfying a given policy and provides a mapping between the parameters defined in the given policy and the parameters required in the identified dataflow.

The DFRT 208 is a runtime environment where the dataflows execute. The DFRT 208 acts as a policy enforcement point for one or more policy domains. The DFRT 208 establishes the current in-scope subject; determines policy domains where multiple policy domains can apply to a subject resulting in the need for multiple data flows; loads the flow or flows from the DFPR 206; transforms assertions in parameters for a dataflow; and executes the final plan. The dataflow planner 210, in one embodiment, comprises a DFRT query module 220, an ordering resolution module 222, a dependency resolution module 224, and an optimizer 226. The DFRT Query Module 220 queries the PDP 204 through the DFRT 208 to establish the current in-scope policy subjects. The ordering resolution module 222 resolves processing order for dataflows returned by the DFPR 206. The dependency resolution module 224 resolves dataflow dependencies. The optimizer 226 eliminates redundant dataflow and outputs the final dataflow plan to the dataflow execution manager 212. For example, the optimizer 226 eliminates duplicate transformations if they can be reused. The dataflow execution manager 212 executes the dataflow plan using the DFRT 208. In one embodiment, the dataflow execution manager 212 comprises a plan converting module 228 that converts the final dataflow plan received from the optimizer 226 to ready-to-run artifacts so that the dataflow can be executed in the DFRT 208.

Dynamic and Automatic Policy-Driven Dataflow Composition

The number of web services available in public and private networks, each with different policies and requirements is increasing very rapidly. As discussed above, conventional dataflow composition systems are unable to overcome the increasingly complex challenges for consuming these services because they are limited in scope and functionality. For example, in some conventional systems a programmer is required to create specialized dataflows based on particular policies before runtime. Other systems require manual work and intervention.

Various embodiments of the present invention, on the other hand, are advantageous over these conventional systems because they dynamically plan, based on a set of policies that are specified for a service, a set of reusable generic dataflows that are sequenced and invoked to satisfy the specified policies. The following is a more detailed discussion of this dynamic and automatic composition of service dataflows based on policies.

In one embodiment, a service request shown as an incoming message 230 in FIG. 2 is received by the dataflow planner 210 from a client 102 requesting a given service. The DFRT query module 220 then queries the DFRT 208 to establish the currently in-scope policy subjects The DFRT 208 then queries the policy decision point 204 to discover the in-scope policy assertions. For each policy assertion 214 returned from the policy store 202 the DFRT 208 determines the policy domain and retrieves the dataflow 236 from the DFPR 206 required to enforce that domain. The DFRT 208 then transforms the assertion into a set of dataflow parameters using the registered transformation 218. The DFRT 208 then returns the list of dataflows and related parameterization to the dataflow planner 210.

If the size of the list of dataflows returned by the DFRT 208 is greater than 1 then the dataflow planner 210 queries the policy store 202 (via the DFRT 208) to retrieve order resolution policies 215. Order resolution policies indicate a priority to assign to a given dataflow. In other words, the ordering resolution policies are used to determine the execution order for the current iteration. For example, it can be determined that if there is a logger dataflow and a router dataflow that the router dataflow runs last. Ordering policies 215 can be defined at system level and at the dataflow/endpoint level. Ordering policies that are defined at endpoint level override system-level policies.

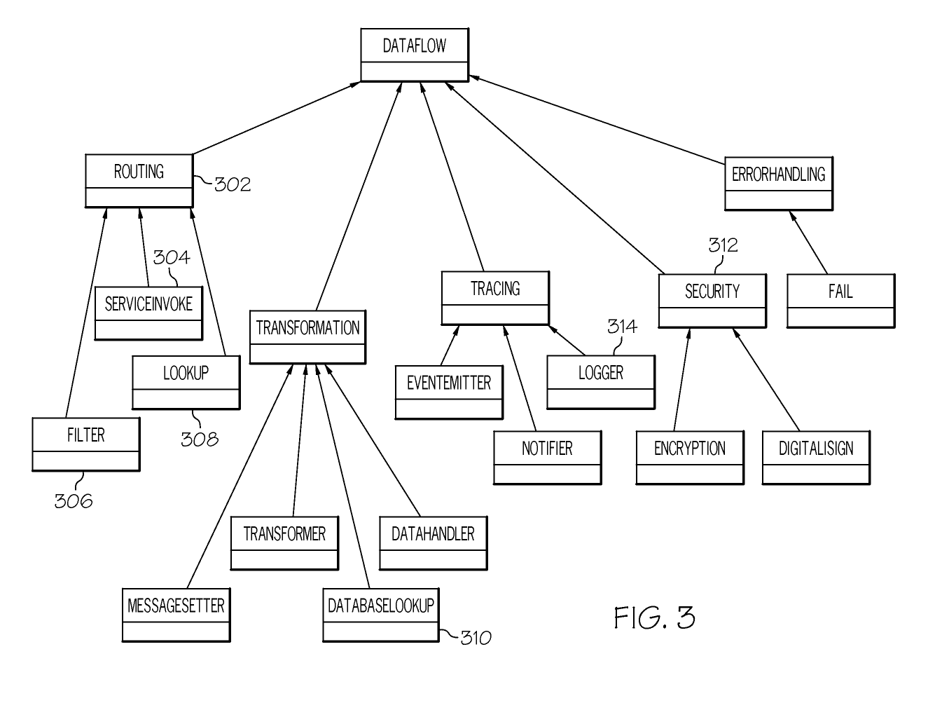

FIG. 3 shows one example of utilizing ordering policies. FIG. 3 shows a plurality of classifications for dataflows organized in a tree structure. This structure is used as an example to illustrate various categories of dataflows. As can be seen from FIG. 3 classifications are hierarchical. For example, the “routing” classification 302 has children classifications of “serviceInvoke” 304, “filter” 306, and “lookup” 308. Each classification can be assigned priorities for execution. For example, the “serviceInvoke” classification 304 can be assigned a priority value of 0; the “databaseLookup” classification 310 can be assigned a priority value of 1; the “security” classification 312 can be assigned a priority value of 2; the “filter” classification 306 can be assigned a priority value of 3; and the “logger” classification 314 can be assigned a priority value of 4. Classifications are then attached to dataflows and used to determine the priority of execution of each dataflow.

The ordering resolution module 222 then resolves the ordering resolution policies 215 and sorts the dataflows accordingly based on the priorities indicated by the ordering policies 215. The dependency resolution module 224 then performs a recursive dependency resolution process. This is advantageous because before a given dataflow executes other dataflows (i.e., dependent dataflows) may be required to achieve the desired end results. In one embodiment, the dependency resolution module 224 selects a current dataflow from the sorted list of dataflows. The dependency resolution module 224 then queries the DFRT 208 to retrieve the dependent policies for the current dataflow. Based on the dependent policies for the current dataflow the dependency resolution module 224 determines if additional dataflows need to be inserted into the current dataflow. If additional dataflows need to be inserted the dataflow planner 210 performs the ordering resolution process for the current dataflow and its inserted dependent dataflows. When all dependencies have been satisfied for all of the dataflows the dependency resolution process completes.

The optimizer 226 then optimizes the resulting sequence of dataflows, referred to as an execution plan 232. For example, the optimizer removes any redundancies, identifies dataflows that can run in parallel, and the like. The dataflow planner 210 then sends the execution plan 232 to the dataflow execution manager 212. The plan converting module 228 then converts the execution plan 232 into a format that is acceptable by the DFRT 208 and runs the plan using the DFRT 208. An outbound message 234 is then generated based on the execution plan 232 and sent to the endpoint, i.e., service.

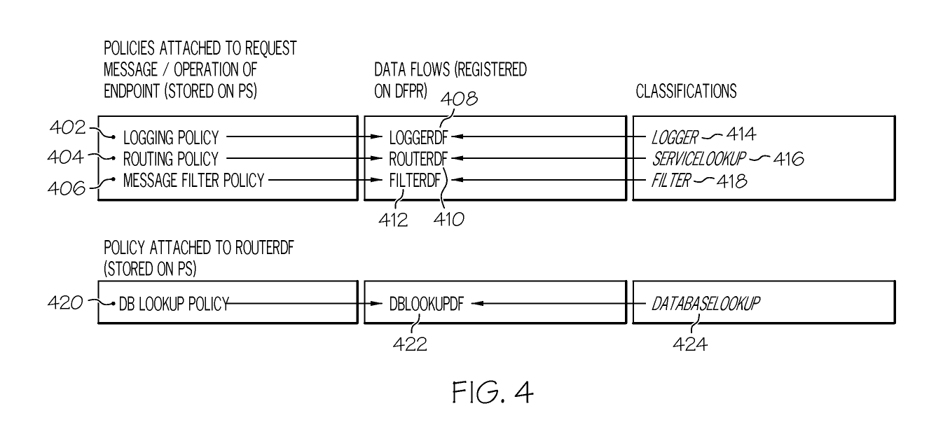

FIGS. 4-6 shows one example of the dependency resolution process discussed above. In particular, FIG. 4 shows that a set of policies is attached to a request message/operation of an endpoint (stored in the policy store 202). For example, FIG. 4 shows a logging policy 402, a routing policy 404, and a message filter policy 406 being attached to the endpoint. These policies are triggered when a given operation of a service is invoked. Each of these policies is associated with one or more dataflows stored in the DPFR 206. For example, the logging policy 402 is associated with a LoggerDF dataflow 408; the routing policy 404 is associated with a RouterDF dataflow 410; and the message filter policy 406 is associated with a FilterDF dataflow 412. A set of classifications (FIG. 3) is associated with each of the dataflows. For example, a logger classification 414 is associated with the LoggerDF dataflow 408; a serviceLookup classification 416 is associated with the RouterDF dataflow 410; and a filter classification 418 is associated with the FilterDF dataflow 412. A policy, which is stored in the policy store 202 can be attached to one of these implementations such as a DB Lookup policy 420, attached to the RouterDF 410.

A message is received from a client 102 requesting a given service. The dataflow planner 210 invokes the DFRT 208 and retrieves a list of dataflows with related transformations for this particular endpoint, as discussed above. For example, the DFRT 208, via the policy decision point 204, determines that this endpoint is associated with logging, routing, and message filtering policies 402, 404, 406. The DFRT 208 then retrieves the LoggerDF 408, RouterDF 410, and FilterDF 412 dataflows and associated transformations from the DFPR 206. Because the DFRT 208 returned more than 1 (or any other given threshold) dataflow, the dataflow planner 210 retrieves one or more ordering policies 215 from the policy store 202 and orders the dataflows accordingly, as discussed above. In the current example, the ordering policies indicate that the LoggerDF 408 has the highest priority, the FilterDF 412 has the next highest priority, and the RouterDF 410 has the lowest priority.

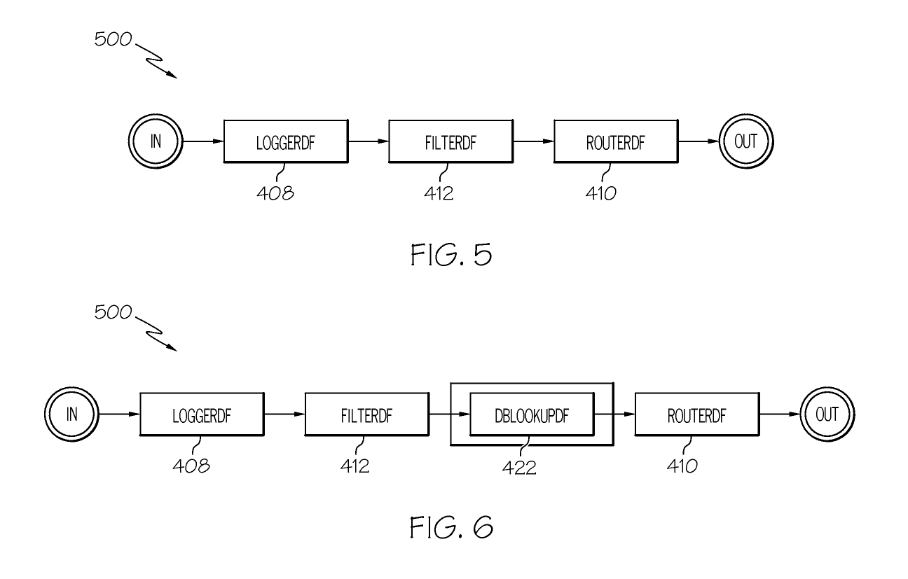

Therefore, based on the ordering policies 215, the dataflow planner 210 creates the execution plan 500 shown in FIG. 5. The execution plan 500 of FIG. 5 indicates that the LoggerDF 408 is to run first, then the FilterDF 412, and the finally the RouterDF 410. The dataflow planner 210 then determines if there are other policies attached to each of these dataflows (dependency resolution discussed above) invoking the DFRT 208 for each dataflow. In the current example, the dataflow planner 210 invokes the policy decision point 204 (through the DFRT 208) to identify the policies such as the DB Lookup policy 420 that are within scope for an endpoint or dataflow such as the RouterDF 410 dataflow. The DFPR 206 is used by the dataflow planner 210 to determine the dataflows, e.g., the DBLookupDF 422, that are used to enforce the policy(s), e.g., DB Lookup policy 420, and how to parameterize these dataflows using transformations 210.

The dataflow planner 210 updates the execution plan 500 of FIG. 5 as shown in FIG. 6. In particular, the dataflow planner adds the DBLookupDF 422 before the RouterDF 410 since the RouterDF 410 requires that the DBLookupDF 422 be performed prior to its operation. It should be noted that if more than one dataflow is returned during the dependency resolution process then the ordering resolution is performed on these flows similar to that already discussed above. The dataflow planner 210 then invokes the DFRT 208 for the DBLookupDF 422 and all dataflows 408, 412 to the left of the DBLookupDF 422 to determine if any of these flows are associated with any policies that require other dataflows. This process is similar to the process that was performed for the RouterDF 410 discussed above. In the current example, no other policies were found so the execution plan 500 is sent to the dataflow execution manager 212 for execution.

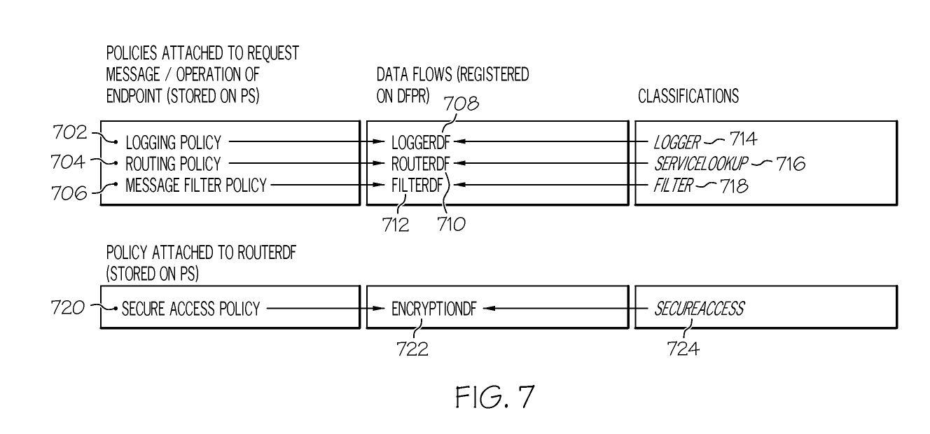

FIGS. 7-11 illustrate a multi-level dependency resolution example. In this example, encryption is required if a message is being sent out to an external source such as a “cloud” environment. The decision of encrypting depends on the result of a lookup on a database, DB, which identifies the type of target the message is being sent to. The result of this lookup is used to turn on the encryption or turn off the encryption.

Similar to the example above, a set of policies are attached to a request message/operation of endpoint. For example, a logging policy 702, a routing policy 704, and a message filter policy 706 are attached to the endpoint. These policies are triggered when a given operation of a service is invoked. Each of these policies is associated with one or more dataflows stored in the DPFR 206. For example, the logging policy 702 is associated with a LoggerDF dataflow 708; the routing policy 704 is associated with a RouterDF dataflow 710; and the message filter policy 706 is associated with a FilterDF dataflow 712. A set of classifications (FIG. 3) is associated with each of the dataflows. For example, a logger classification 714 is associated with the LoggerDF dataflow 708; a serviceLookup classification 716 is associated with the RouterDF dataflow 710; and a filter classification 718 is associated with the FilterDF dataflow 712. A policy, which is stored in the policy store 202 can be attached to one of these implementations such as a Secure Access policy 720, attached to the RouterDF 710. This Secure Access policy 720 is associated with an EncryptionDF dataflow 722, which has a secureAccess classification 724.

A message is received from a client 102 requesting a given service. The dataflow planner 210 invokes the DFRT 208 and retrieves a list of dataflows with related transformations for this particular endpoint, as discussed above. For example, the DFRT 208, via the policy decision point 204, determines that this endpoint is associated with logging, routing, and message filtering policies 702, 704, 706. The DFRT 208 then retrieves the LoggerDF 708, RouterDF 710, and FilterDF 712 dataflows and associated transformations from the DFPR 206. Because the DFRT 206 returned more than 1 dataflow, the dataflow planner 210 retrieves one or more ordering policies 215 from the policy store 202 and orders the dataflows accordingly, as discussed above. In the current example, the ordering policies indicate that the LoggerDF 708 has the highest priority, the FilterDF 712 has the next highest priority, and the RouterDF 710 has the lowest priority.

Therefore, based on the ordering policies, the dataflow planner 210 creates the execution plan 800 shown in FIG. 8. The execution plan 800 of FIG. 8 indicates that the LoggerDF 708 is to run first, then the FilterDF 712, and then finally the RouterDF 710. The dataflow planner 210 then determines if there are other policies attached to each of these dataflows (dependency resolution discussed above) invoking the DFRT 208 for each dataflow. In the current example, the dataflow planner 210 invokes the policy decision point 204 (through the DFRT 208) to identify the policies such as the Secure Access policy 720 that are within scope for an endpoint or dataflow such as the EncryptionDF 722.

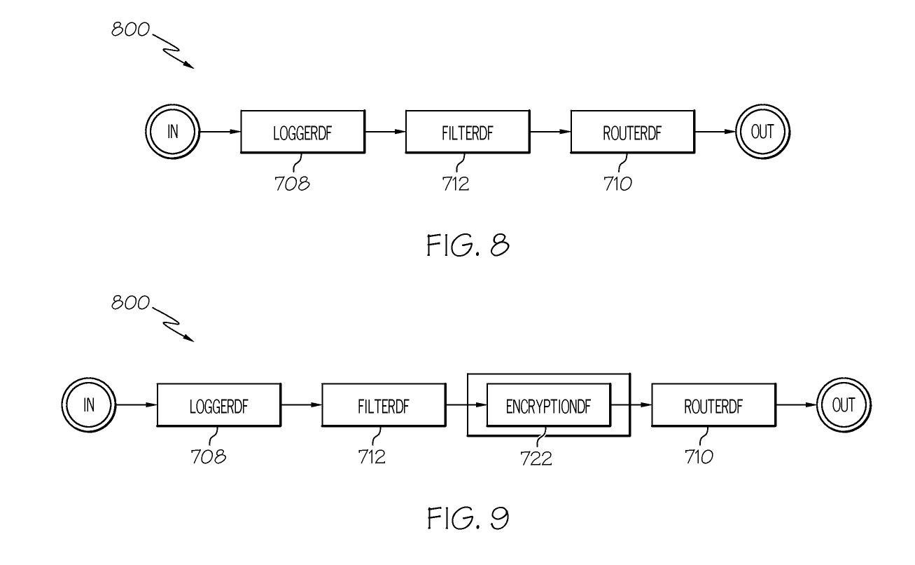

The dataflow planner 210 updates the execution plan 800 of FIG. 8 as shown in FIG. 9. In particular, the dataflow planner 210 adds the EncryptionDF 722 before the RouterDF 710 since the RouterDF 710 requires that the EncryptionDF 722 be performed prior to its operation to determine whether or not encryption should be applied to the message. It should be noted that if more than one dataflow is returned during the dependency resolution process then the ordering resolution is performed on these flows similar to that already discussed above. The dataflow planner 210 then invokes the DFRT 208 for the EncryptionDF 722 and all dataflows to the left of the EncryptionDF 722 to determine if any of these flows are associated with any policies that require other dataflows. This process is similar to the process that was performed for the RouterDF 710 discussed above.

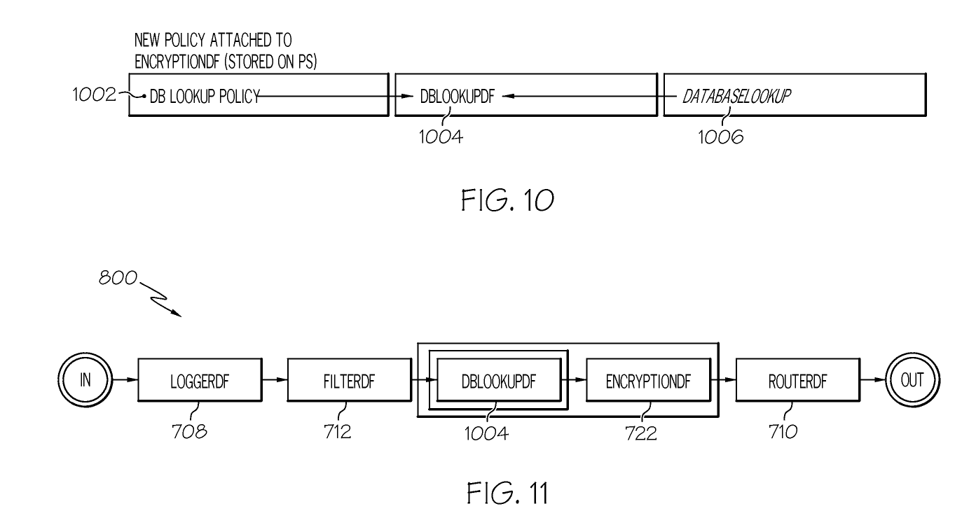

In the current example, the dataflow planner 210 determines that the EncryptionDF 722 is associated with a DBLookup policy 1002 that is associated with a DBLookupDF 1004 with a databaseLookup classification 1006 as shown in FIG. 10. The DFRT 208 returns DBLookupDF 1004 and any transformation information to the dataflow planner 210. As discussed above, EncryptionDF 722 is conditional as it can be turned on/off with a parameter, such as (but not limited to) a “switch” parameter, at runtime depending on the target of the message. The “switch” parameter is set in a common context by the DBLookupDF 1004. The dataflow planner 210 once again updates the execution plan 800 as shown in FIG. 11. As shown in FIG. 11 the dataflow planner 210 has inserted the DBLookupDF 1004 before the EncryptionDF 722 since the encryption depends on the result of the database lookup. The dataflow planner 210 then invokes the DFRT 208 for the DBLookupDF 1004 and all dataflows to the left of the DBLookupDF 1004 to determine if any of these flows are associated with any policies that require other dataflows. In the current example, no other policies were found so the execution plan 800 is sent to the dataflow execution manager 212 for execution.

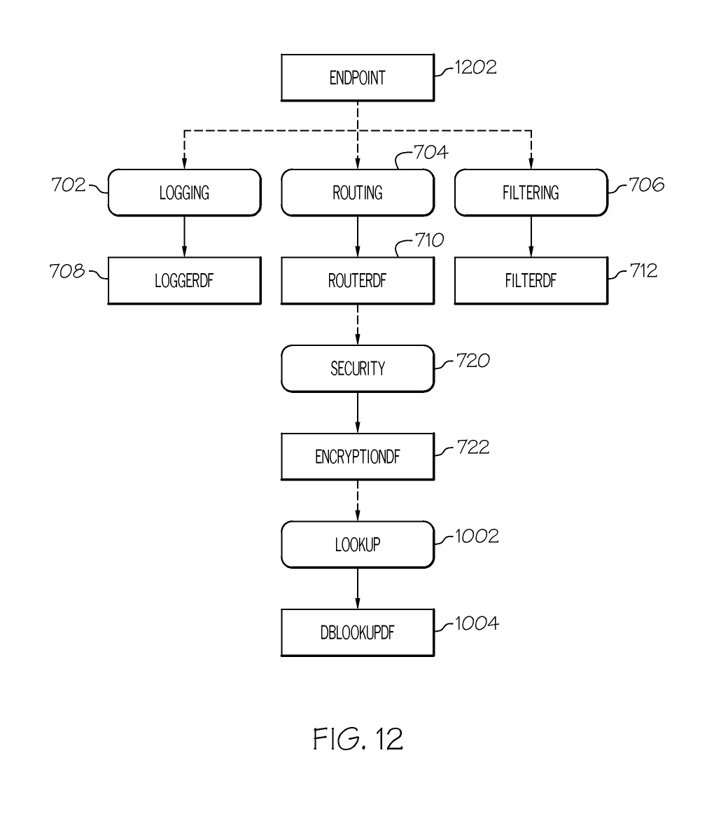

FIG. 12 provides a representation of the policy dependencies in the example of FIGS. 7-11. As can be seen from FIG. 12, the endpoint 1202 is associated with a logging policy 702, a routing policy 704, and a filtering policy 706. The logging policy 702 is associated with a LoggerDF 708. The routing policy 704 is associated with a RouterDF 710. The filtering policy 706 is associated with a FilterDF flow 712. The RouterDF 710 is associated with a security policy 720. The security policy 720 is associated with an EcryptionDF 722. The EcryptionDF 722 is associated with a DB lookup policy 1002. The DB lookup policy 1002 is associated with a DBLookupDF 1004. Dashed lines represent dependencies, solid lines represent policy enforcement, square boxes indicate dataflows, and round corner boxes indicate policies.

When a dataflow has a dependent policy on another dataflow the parent dataflow may need to receive parameters from the dependent dataflow as shown above. For example, the EncryptionDF 722 required parameters from the DBLookup dataflow 1004 in order to determine whether encryption should be used. The required parameters, in one embodiment, are declared as part of the domain mapping information within the DFPR.

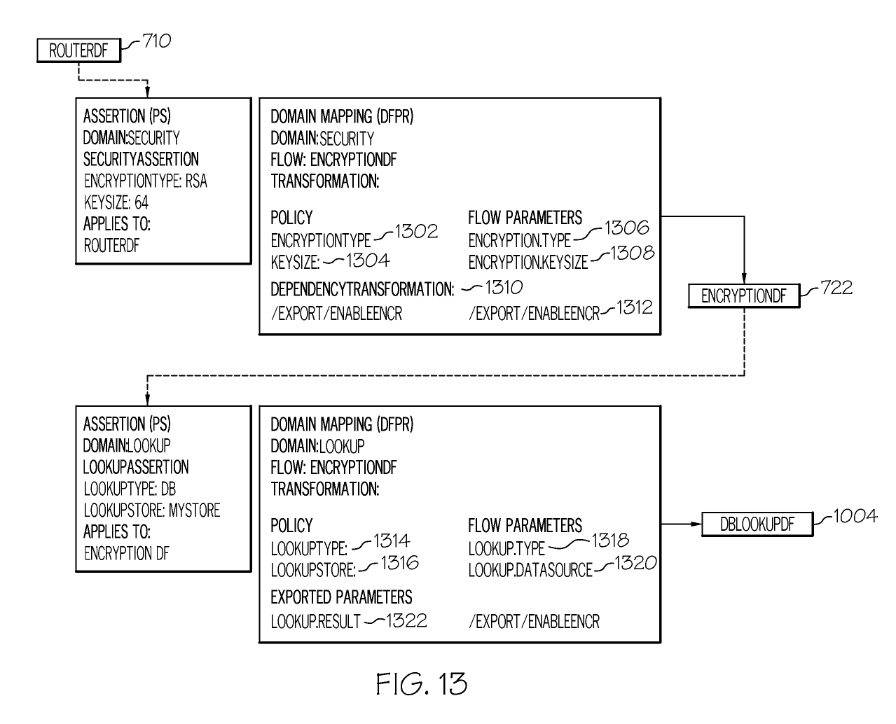

FIG. 13 shows an example of propagating parameters between dataflows. FIG. 13 shows that the RouterDF 710 is attached to a policy (assertion) with a domain of “security”. The SecurityAssertion indicates that the encryption type is to be set to RSA with a KeySize of 64. FIG. 13 also shows that for this particular policy, SecurityAssertion, there is a dataflow, EncryptionDF 722, to enforce this policy. As can be seen, there is a mapping between policy parameters, EncryptionType 1302 and KeySize 1304, and flow parameters, Encryption.type 1306 and Encryption.keySize 1308. The mapping information within the DFPR 206 also comprises dependency transformation information 1310 that indicates the parameters to obtain from another dataflow and where to obtain these parameters. For example, the dependency transformation 1310 information in FIG. 13 for the RouterDF 710 indicates that the Encryption.enabled parameter 1312 needed to determine whether or not to apply encryption is located within the “/export/enableEncr” location.

FIG. 13 further shows that a LookupAssertion policy is attached to the EncryptionDF 722, and the LookupAssertion policy is enforced by DBLookupDF flow 1004. The LookupAssertion policy parameters of LookupType 1314 and LookupStore 1316 are mapped to the flow parameters of Lookup.type 1318 and Lookup.dataSource 1320, respectively. The domain mapping information for the DBLookup flow indicates that a Lookup.result parameter 1322 is exported to “/export/enableEncr” location. As can be seen, the “/export/enableEncr” location is a shared space that is shared between the EncryptionDF flow 722 and the DBLookupDF flow 1004. This allows the Lookup.result parameter 1322 from the DBLookupDF 1004 to be mapped to the Encryption.enabled parameter 1312 of the EncryptionDF 722. In other words, the EncryptionDF 722 is able to obtain the parameter it needs from the “/export/enableEncr” location based on the Lookup.result parameter 1322 stored in the “/export/enableEncr” by the DBLookupDF 1004.

In addition to the processes/operations discussed above, other processes/operations that are not required to be explicitly defined in policies can also be performed. One example of these types of processes/operations is the automatic transformation of messages. In this embodiment, the dataflow planner 210 compares a message type associated with a message that is being inputted into a dataflow or endpoint with the message types supported by the dataflow/endpoint. Message types supported by dataflows and endpoints can be stored in, for example, a service registry. If the input message is the incoming message for the composed dataflow then the message type of the incoming message is used in the comparison. If the input message is coming from another dataflow then the message type for this dataflow is retrieved from a service registry where the dataflow is registered. If the dataflow planner 210, based on the comparison, determines that the incoming message type and the required message type do not match the dataflow planner 210 determines if an available transformation for the incoming message exists. If a transformation does exist then the dataflow planner 210 inserts the transformation after all dependencies have been resolved.

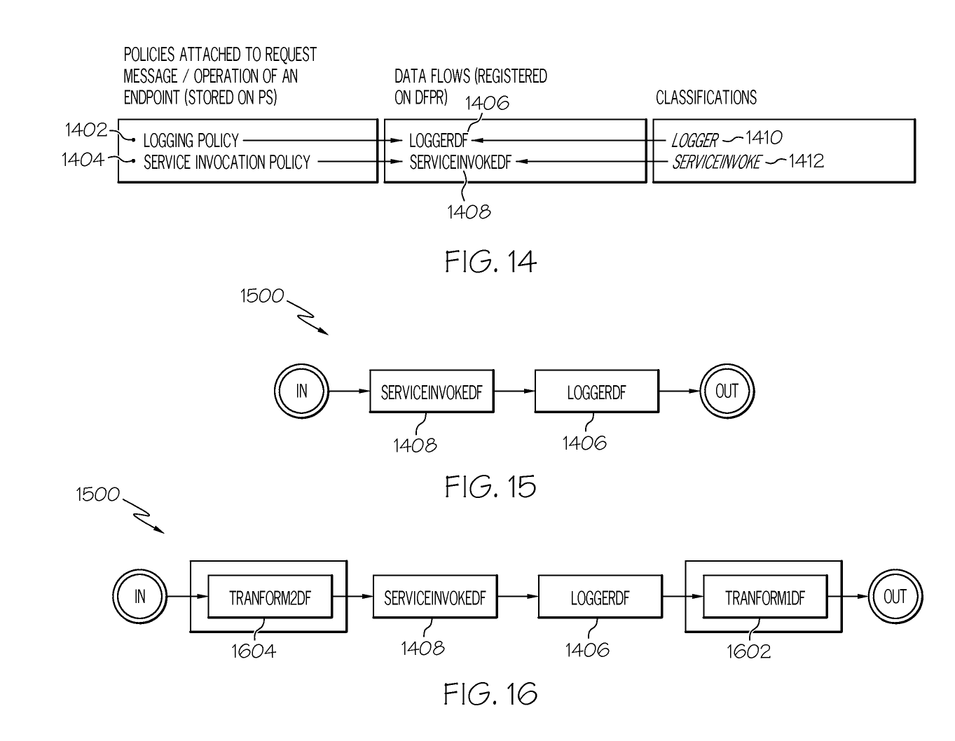

FIGS. 14-16 show an example of this automatic transformation process. In particular, FIG. 14 shows that an endpoint is associated with a logging policy 1402 and a service invocation policy 1404. The logging policy 1402 is associated with a LoggerDF dataflow 1406 comprising a logger classification 1410. The service invocation policy 1404 is associated with a ServiceInvokeDF dataflow 1408 comprising a seviceinvoke classification 1412.

In this example, the LoggerDF 1406 and the ServiceInvokeDF 1408 use a normalized interface described by the Web Service Description Language (WSDL) while the input message and the endpoint use implementation-specific interfaces, described by the WSDL. The dataflow planner 210 receives a request for a service and invokes the DFPR 206 to retrieve a set of dataflows with related parameter transformations associated with the service. In this example, the dataflow planner 210 retrieves the LoggerDF 1406 and the ServiceInvokeDF 1408. Similar to the processes discussed above, the dataflow planner 210 builds the execution plan 1500 as shown in FIG. 15 with the ServiceInvokeDF 1408 executing before the LoggerDF 1406. The dataflow planner then performs message type matching starting from the endpoint and traversing the graph, e.g., execution plan 1500, from right to left. The dataflow planner 210 checks the message format required by the endpoint and the message format of the output of the LoggerDF 1406 and determines that a transformation is required. The dataflow planner 210 locates a dataflow, Transform1DF 1602, for a transformation that is able to map between the input message format and the outbound message format. The dataflow planner 210 adds the Transform1DF 1602 flow to the execution plan 1500 as shown in FIG. 16. The dataflow planner 210 continues to traverse the graph right to left until it identifies a mismatch between ServiceInvokeDF 1408 and the input message to the composite dataflow. The dataflow planner 210 identifies another dataflow, Transform2DF 1604, to transform the input message to be compatible with the ServiceInvokeDF flow 1408. The dataflow planner adds Transform2DF to the execution plan 1500 before ServiceInvokeDF as shown in FIG. 16. The execution plan 1500 is then sent to the dataflow execution manager 212 for execution within the DFRT.

As can be seen from the above discussion the dataflow planner 210 dynamically and automatically (i.e., without user intervention) composes service dataflows based on policies. The dataflow planner dynamically plans a set of reusable generic dataflows that are sequenced and invoked to satisfy the specified policies for a requested service. Various embodiments allow the behavior of a dataflow to be modified both dynamically and declaratively. Dynamic modification refers to modifying how a dataflow operates on a per message basis. Declarative modification refers performing these modifications via a simple configuration change, rather than by having to make programming changes. This is advantageous when, for example, a dataflow needs to be able to deal with many different cases and has a requirement to dynamically add new cases that it can deal with. This occurs in many situations, but is particularly characteristic of service gateway connectivity scenarios, in which a single dataflow must cope with service invocations destined for many different services. The dataflow may need to perform a different mediation for each target service and may need to cope with new target services. Each service invocation, destined for each target service, may need different operations performed on it.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Operational Flow Diagrams

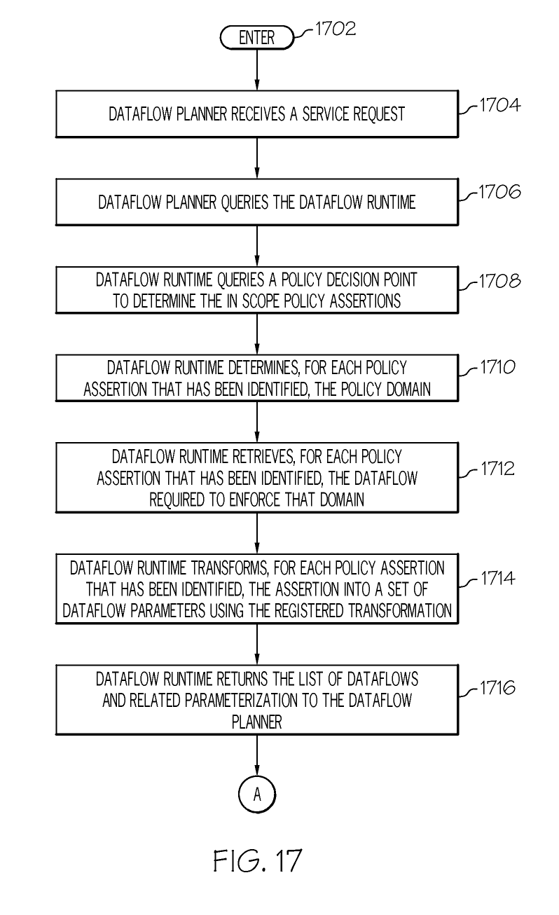

Referring now to FIGS. 17-20, the flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

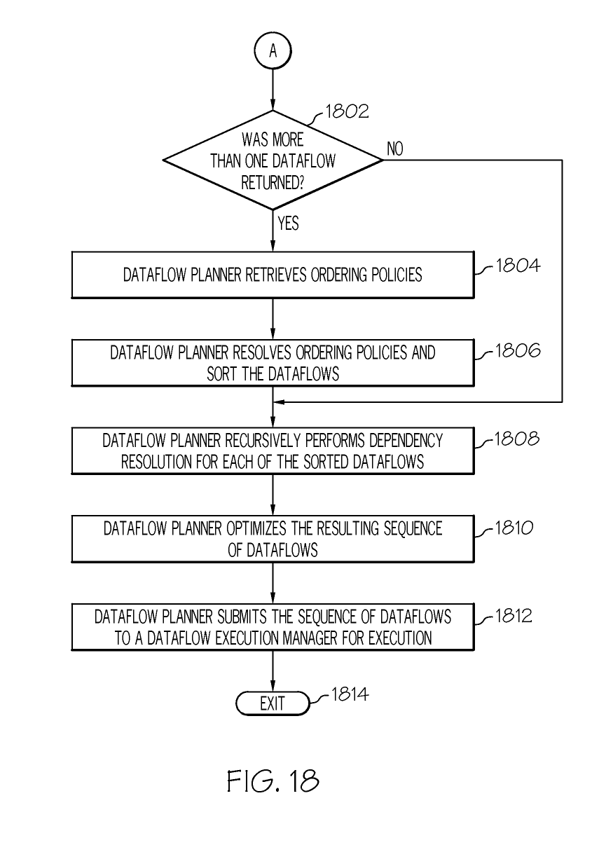

FIGS. 17-18 are operational flow diagrams illustrating one example of performing policy driven dynamic composition of data flows. The operational flow of FIG. 17 starts at step 1702 and flows directly into step 1704. The dataflow planner 210, at step 1704, receives a service request 230. The dataflow planner 210, at step 1706, invokes the DFRT 208. The DFRT 208, at step 1708, queries a policy decision point 204 to determine the in-scope policy assertions. The DFRT 208, at step 1710, determines, for each policy assertion that has been identified, the policy domain. The DFRT 208, at step 1712, retrieves, for each policy assertion that has been identified, the dataflow required to enforce that domain. The DFRT 208, at step 1714, transforms, for each policy assertion that has been identified, the assertion into a set of dataflow parameters using the registered transformation. The DFRT 208, at step 1716, returns the list of dataflows and related parameterization to the dataflow planner 210. The control then flows into entry point A of FIG. 18.

The dataflow planner 210, at step 1802, determines if more than 1 dataflow was returned. If the result of this determination is negative, the control flows to step 1808. If the result of this determination is positive, the dataflow planner 210, at step 1804, retrieves ordering policies from the policy store 202. The dataflow planner 210, at step 1806, resolves the ordering policies and sorts the dataflows in an execution plan accordingly. The dataflow planner 210, at step 1808, recursively performs a dependency resolution process for each of the sorted dataflows. The dataflow planner 210, at step 1810, optimizes the resulting sequence of dataflows. The dataflow planner 210, at step 1812, then submits the sequence of data flows to the dataflow execution manager 212 for execution. The control flow then exits at step 1814.

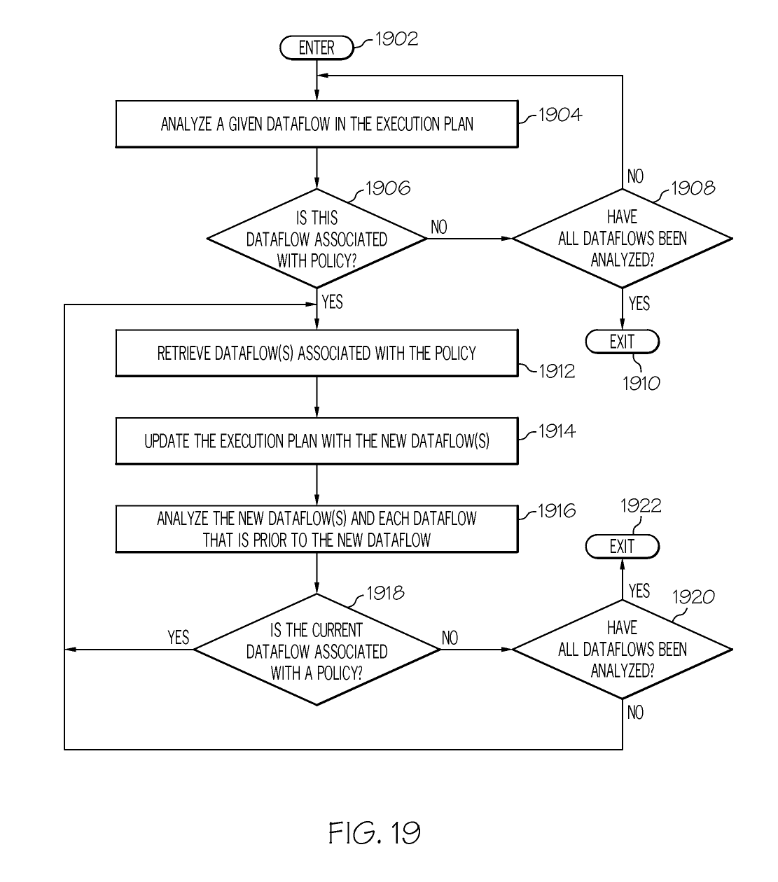

FIG. 19 is an operational flow diagram illustrating one example of a process for resolving dependencies in a dataflow execution plan. The operational flow of FIG. 19 starts at step 1902 and flows directly into step 1904. The dataflow planner 210, at step 1904, analyzes a given dataflow in the execution plan 232. The dataflow planner 210, at step 1906, determines if this dataflow is associated with a policy. If the result of this determination is negative, the dataflow planner 210, at step 1908, determines if all dataflows in the plan 232 have been analyzed. If the result of this result is positive, the control flow then exits at step 1910. If the result of this determination is negative, the control flow then returns to step 1904 so that another dataflow can be analyzed.

If the result of the determination at step 1906 is positive, the dataflow planner 210, at step 1912, retrieves a dataflow(s) associated with the policy. The dataflow planner 210, at step 1914, updates the execution plan 232 with the new dataflow(s). The dataflow planner 210, at step 1916, analyzes the new dataflow(s) and each dataflow that is prior to the new dataflow. The dataflow planner 210, at step 1918, determines if the current dataflow is associated with a policy. If the result of this determination is positive, the control flow returns to step 1912. If the result of this determination is negative, the dataflow planner 210, at step 1920 determines if all dataflows have been analyzed. If the result of this determination is positive, the control flow exits at step 1922. If the result of this determination is negative, the control flow returns to step 1912.

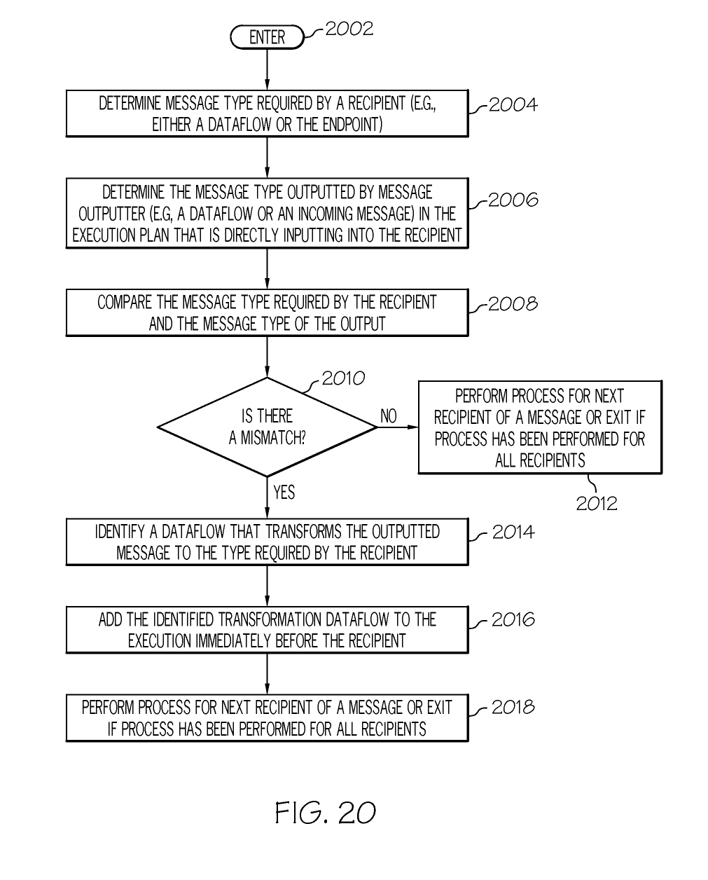

FIG. 20 is an operational diagram illustrating one example of a process for performing automatic transformations of messages within an execution plan. The operational flow of FIG. 20 starts at step 2002 and flows directly into step 2004. The dataflow planner 210, at step 2004, determines a message type associated with a current recipient (e.g., either a dataflow or the endpoint in an execution plan) of a message. The dataflow planner 210, at step 2006, determines the message type outputted by a message outputter (e.g., a dataflow or an incoming message of the execution plan) that is directly inputting into the recipient.

The dataflow planner 210, at step 2008, compares the message type required by the recipient and the message type of the outputter. The dataflow planner 210, at step 2010, determines if there is a mismatch. If the result of this determination is negative, the dataflow planner 210, at step 2012, either performs the above processes for the next recipient of a message or exits if this process has been performed for all recipients in the execution plan. If the result of this determination is positive, the dataflow planner 210, at step 2014, identifies a dataflow that transforms the outputted message to the type required by the recipient. The dataflow planner 210, at step 2016, adds the identified transformation dataflow to the execution plan immediately before the recipient. The dataflow planner 210, at step 2018, either performs the above processes for the next recipient of a message or exits if this process has been performed for all recipients in the execution plan.

Information Processing System

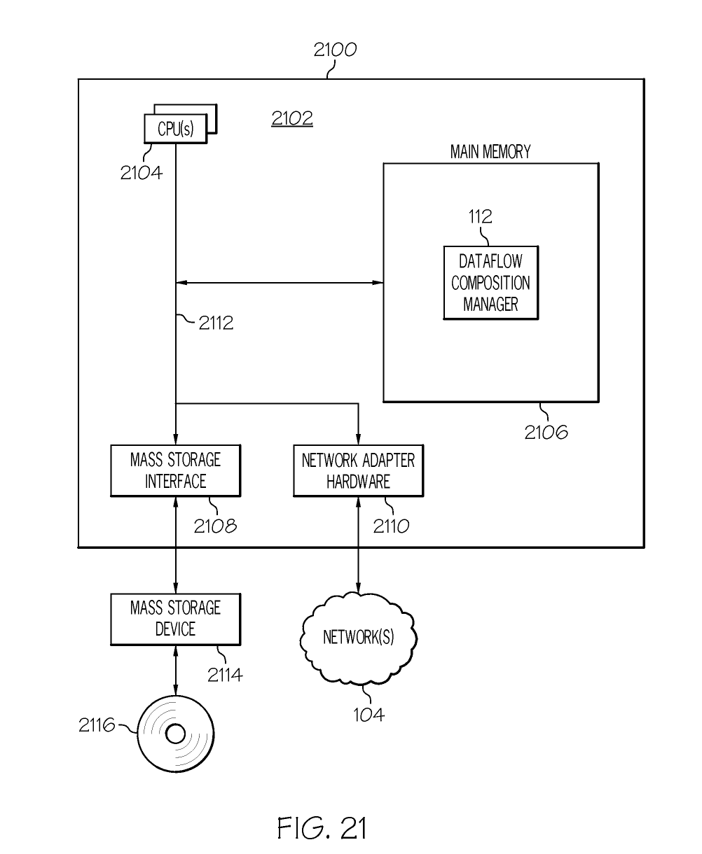

FIG. 21 is a block diagram illustrating a more detailed view of an information processing system 2100, such as the server system 106, that can be utilized in the operating environment 100 discussed above with respect to FIG. 1. The information processing system 2100 is based upon a suitably configured processing system adapted to implement one or more embodiments of the present invention. Similarly, any suitably configured processing system can be used as the information processing system 2100 by embodiments of the present invention.

The information processing system 2100 includes a computer 2102. The computer 2102 has a processor(s) 2104 that is connected to a main memory 2106, mass storage interface 2108, and network adapter hardware 2110. A system bus 2112 interconnects these system components. The main memory 2106, in one embodiment, comprises the dataflow composition manager 112 and its components discussed above.

Although illustrated as concurrently resident in the main memory 2106, it is clear that respective components of the main memory 2106 are not required to be completely resident in the main memory 2106 at all times or even at the same time. In one embodiment, the information processing system 2100 utilizes conventional virtual addressing mechanisms to allow programs to behave as if they have access to a large, single storage entity, referred to herein as a computer system memory, instead of access to multiple, smaller storage entities such as the main memory 2106 and data storage device 2116. Note that the term “computer system memory” is used herein to generically refer to the entire virtual memory of the information processing system 2100.

The mass storage interface 2108 is used to connect mass storage devices, such as mass storage device 2114, to the information processing system 2100. One specific type of data storage device is an optical drive such as a CD/DVD drive, which may be used to store data to and read data from a computer readable medium or storage product such as (but not limited to) a CD/DVD 2116. Another type of data storage device is a data storage device configured to support, for example, NTFS type file system operations.

Although only one CPU 2104 is illustrated for computer 2102, computer systems with multiple CPUs can be used equally effectively. Embodiments of the present invention further incorporate interfaces that each includes separate, fully programmed microprocessors that are used to off-load processing from the CPU 2104. An operating system (not shown) included in the main memory is a suitable multitasking operating system such as any of the Linux, UNIX, Windows, and Windows Server based operating systems. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 2100. The network adapter hardware 2110 is used to provide an interface to a network 104. Embodiments of the present invention are able to be adapted to work with any data communications connections including present day analog and/or digital techniques or via a future networking mechanism.

Although the exemplary embodiments of the present invention are described in the context of a fully functional computer system, those of ordinary skill in the art will appreciate that various embodiments are capable of being distributed as a program product via CD or DVD, e.g. CD 2116, CD ROM, or other form of recordable media, or via any type of electronic transmission mechanism.

Non-Limiting Examples

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
performing with a computer processor the following:
receiving a request from a client;
retrieving, in response to receiving the request, a first set of dataflows that enforces at least one set of policies, wherein each dataflow in the first set of dataflows is a software component that processes a set of messages sent from the client to a service;
generating a dataflow execution plan comprising the first set of dataflows;
determining that at least one dataflow in the first set of dataflows is associated with a dataflow policy;
retrieving, in response to the determining, at least a second set of dataflows associated with the dataflow policy; and
inserting the at least second set of dataflows into the dataflow execution plan preceding the at least one dataflow.

2. The method of claim 1, further comprising:
identifying, in response to receiving the request, a set of policies associated with at least one of:
the service;
the set of messages; and
a set of policy subjects associated with the dataflow policy.

3. The method of claim 2, wherein the first set of dataflows is retrieved based on the set of policies that have been identified.

4. The method of claim 1, further comprising:
determining, in response to retrieving the first set of dataflows, that a number of dataflows above a given threshold has been retrieved;
retrieving, in response to the number of dataflows in the first set of dataflows being above a given threshold, a set of ordering policies comprising a set of priority information; and
sorting the first set of dataflows based on the set of priority information in the set of ordering policies.

5. The method of claim 1, further comprising:
determining that at least two dataflows in the dataflow execution plan are redundant; and
removing one of the at least two dataflows that are redundant from the dataflow execution plan.

6. The method of claim 1, further comprising:
executing the dataflow execution plan; and
executing at least one additional dataflow execution plan in parallel with the dataflow execution plan.

7. The method of claim 1, further comprising:
determining that one of the at least second set of dataflows and a dataflow preceding the at least second set of dataflows in the dataflow execution plan is associated with a dataflow policy;
retrieving at least a third set of dataflows associated with the dataflow policy; and
inserting the at least third set of dataflows into the dataflow execution plan preceding the one of the at least second set of dataflows and the dataflow preceding the at least second set of dataflows.

8. The method of claim 1, further comprising:
mapping a set of parameters required by the at least one dataflow in the first set of dataflows to a set of parameters provided by the at least second set of dataflows.

9. The method of claim 8, wherein the mapping further comprises:
identifying a common addressable space shared between the at least one dataflow and the at least second set of dataflows.

10. The method of claim 1, wherein the service is a web service.

11. A system, comprising:
a memory;
a processor communicatively coupled to the memory; and
a dataflow composition manager configured to:
receive a request from a client;
retrieve, in response to the request being received, a first set of dataflows that enforces at least one set of policies, wherein each dataflow in the first set of dataflows is a software component that processes a set of messages sent from the client to a service;
generate a dataflow execution plan comprising the first set of dataflows;
determine that at least one dataflow in the first set of dataflows is associated with a dataflow policy;
retrieve, in response to the determining, at least a second set of dataflows associated with the dataflow policy; and
insert the at least second set of dataflows into the dataflow execution plan preceding the at least one dataflow.

12. The system of claim 11, wherein the dataflow composition manager is further configured to:
identify, in response to the request being received, a set of policies associated with at least one of:
the service;
the set of messages; and
a set of policy subjects associated with the dataflow policy.

13. The system of claim 11, wherein the dataflow composition manager is further configured to:
determine, in response to the first set of dataflows being retrieved, that a number of dataflows above a given threshold has been retrieved;
retrieve, in response to the number of dataflows in the first set of dataflows being above a given threshold, a set of ordering policies comprising a set of priority information; and
sort the first set of dataflows based on the set of priority information in the set of ordering policies.

14. The system of claim 11, wherein the dataflow composition manager is further configured to:
determine that at least two dataflows in the dataflow execution plan are redundant; and
remove one of the at least two dataflows that are redundant from the dataflow execution plan.

15. The system of claim 11, wherein the dataflow composition manager is further configured to:
determine that one of the at least second set of dataflows and a dataflow preceding the at least second set of dataflows in the dataflow execution plan is associated with a dataflow policy;
retrieve at least a third set of dataflows associated with the dataflow policy; and
insert the at least third set of dataflows into the dataflow execution plan preceding the one of the at least second set of dataflows and the dataflow preceding the at least second set of dataflows.

16. The system of claim 11, wherein the dataflow composition manager is further configured to:
map a set of parameters required by the at least one dataflow in the first set of dataflows to a set of parameters provided by the at least second set of dataflows, wherein the mapping comprises identifying a common addressable space shared between the at least one dataflow and the at least second set of dataflows.

17. A computer program product comprising computer readable storage medium having computer readable program code embodied therewith, the computer readable program code comprising computer readable program code configured to:
receive a request from a client;
retrieve, in response to receiving the request, a first set of dataflows that enforces at least one set of policies, wherein each dataflow in the first set of dataflows is a software component that processes a set of messages sent from the client to a service;
generate a dataflow execution plan comprising the first set of dataflows;
determine that at least one dataflow in the first set of dataflows is associated with a dataflow policy;
retrieve, in response to the determining, at least a second set of dataflows associated with the dataflow policy; and
insert the at least second set of dataflows into the dataflow execution plan preceding the at least one dataflow.

18. The computer program product of claim 17, wherein the computer readable program code is further configured to:
identify, in response to the request being received, a set of policies associated with at least one of:
the service;
the set of messages; and
a set of policy subjects associated with the dataflow policy.

19. The computer program product of claim 17, wherein the computer readable program code is further configured to:
determine, in response to the first set of dataflows being retrieved, that a number of dataflows above a given threshold has been retrieved;
retrieve, in response to the number of dataflows in the first set of dataflows being above a given threshold, a set of ordering policies comprising a set of priority information; and
sort the first set of dataflows based on the set of priority information in the set of ordering policies.

20. The computer program product of claim 17, wherein the computer readable program code is further configured to:
determine that at least two dataflows in the dataflow execution plan are redundant; and
remove one of the at least two dataflows that are redundant from the dataflow execution plan.

21. The computer program product of claim 17, wherein the computer readable program code is further configured to:
determine that one of the at least second set of dataflows and a dataflow preceding the at least second set of dataflows in the dataflow execution plan is associated with a dataflow policy;
retrieve at least a third set of dataflows associated with the dataflow policy; and
insert the at least third set of dataflows into the dataflow execution plan preceding the one of the at least second set of dataflows and the dataflow preceding the at least second set of dataflows.

22. The computer program product of claim 17, wherein the computer readable program code is further configured to:
map a set of parameters required by the at least one dataflow in the first set of dataflows to a set of parameters provided by the at least second set of dataflows, wherein the mapping comprises identifying a common addressable space shared between the at least one dataflow and the at least second set of dataflows.

23. A method comprising:
performing on a computer processor the following:
retrieving a dataflow execution plan comprising a set of dataflows, wherein a dataflow is a software component that processes messages sent from a client to a service;
selecting one of an endpoint of the dataflow execution plan and a dataflow in the dataflow execution plan;
determining an incoming message type required by the endpoint or dataflow that has been selected;
determining an output message type provided by one of a dataflow and service request in the dataflow execution plan immediately preceding the endpoint or dataflow that has been selected;
comparing the incoming message type that has been determined and the output message type that has been determined;
determining, based on the comparing, that the incoming message type and the output message type fail to match; and
inserting a transformation dataflow into the dataflow execution plan immediately preceding the endpoint or the dataflow that has been selected, wherein the transformation dataflow automatically transforms an output message of at least one of the one of the dataflow and service request to the incoming message type required by the endpoint or dataflow that has been selected.
